(19) United States
(12) Patent Application Publication
(10) Pub. No.: US 2006/0250818 A1
(43) Pub. Date: Nov. 9, 2006

(54) Backlight device

(75) Inventor: Akimitsu Tsuda, Miki-shi, Hyogo (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/567,170

(22) PCT Filed: Aug. 13, 2004
(86) PCT No.: PCT/IB04/51456

§ 371 Date: Feb. 3, 2006

(51) Int. Cl. F21V 7/04; F21V 5/00

(52) U.S. Cl. 362/607; 362/330

(57) ABSTRACT

An asymmetric prism sheet 15 has a plurality of projections 17 having prism shape on its surface. The projection 17 comprises a first inclined surface 17a having a relatively gentle slope (easy slope) and a second inclined surface 17b having a relatively steep slope (steep slope). A base angle 17d on the side of the second surface 17b is α° and a base angle 17c on the side of the first surface 17a is β°. In the case that the light enters into the asymmetric prism sheet 15, which has the above-mentioned structure, from the bottom surface 15a (light guide plate 11), the light is mainly emitted in the substantially vertical direction (a direction inclined by relatively small angle to the vertical direction) in the first inclined surface 17a (arrows X), and is mainly emitted in the inclined direction (a direction inclined by relatively large angle to the vertical direction) in the second inclined surface 17b (arrows Y).

### TECHNICAL FIELD

The present invention relates to a backlight device used as a light source of liquid crystal display devices, in particular to a backlight device using the luminance improving film.

### BACKGROUND ART

In a transmissive type of liquid crystal display device or a transflective type of liquid crystal display device, a light source provided inside the device is mainly used, while exterior light is partially used. As the light source, a backlight is used.

To supply light from the rear side of the liquid crystal cell, the backlight is arranged on the rear side of the liquid crystal cell as viewed from the display side of the device. The backlight is mainly comprised of a light guide plate such that its main surface is provided opposite and substantially parallel to the surface of the rear side of the liquid crystal cell, and an edge light (side light) that is arranged on an edge surface side of the light guide plate and that emits light to the edge surface. Further, a reflective sheet is arranged on the opposite side to the liquid crystal cell side of the light guide plate.

In such an arrangement, the light from the edge light propagates inside the light guide plate is reflected by the light emitting means provided on the light guide plate and the reflective sheet arranged outside the light guide plate, thereby changed in propagation direction toward the liquid crystal cell, and incident on the liquid crystal cell.

In the conventional backlight, in order to gather the light from the light guide plate to improve the luminance of a liquid crystal panel, a prism sheet, which has a plurality of projections in the shape of a prism on its surface, is arranged on the liquid crystal cell side of the light guide plate.

FIG. 1 shows the conventional prism sheet. The prism sheet 1 has a plurality of projections 2 in the shape of a prism on its surface. In the projections 2, each vertex angle is set at about 90 degrees. The light in various directions incident from the lower side (flat surface) of the light guide plate is changed in its direction to a substantially vertical direction by the projections 2 of the prism sheet 1 (see arrows in FIG. 1). By thus arranging the prism sheet 1 on the liquid crystal cell side of the light guide plate, it is possible to change light in various directions from the light guide plate to the substantially vertical direction, improve the light-gathering characteristic, and improve the luminance in the vertical direction of the liquid crystal panel.

Meanwhile, in recent years, liquid crystal display devices have been required that improve the luminance in the vertical direction of the liquid crystal panel, while implementing a wide luminance-viewing angle (viewing angle exhibiting adequate luminance). However, in the prism sheet 1 as described above, since the projections are designed particularly to improve the luminance in the vertical direction, the luminance-viewing angle is sacrificed. Therefore, it is impossible to realize a wide luminance-viewing angle in a liquid crystal display device provided with the backlight using the conventional prism sheet.

### DISCLOSURE OF INVENTION

It is an object of the present invention to provide a backlight device that is able to realize a liquid crystal display device exhibiting the improved luminance in the vertical direction and the wide luminance-viewing angle.

A backlight device according to the present invention comprises the light guide means that has a pair of main faces facing each other and edge faces and that guides the light from a light source arranged at one of the edge faces, luminance/luminance-viewing angle improvement means that is arranged on the side of one main face of the light guide means and that emits the light in a substantially normal direction to the main face and in the direction having a predetermined angle to the normal direction, and reflective means arranged on the other main face of the light guide means.

According to this arrangement, it is possible to emit the light in the substantially normal direction to the main face and in the direction having a predetermined angle to the normal direction, and therefore, it is possible to improve the luminance in the vertical direction, while improving the luminance in the direction having a predetermined angle to the normal direction. As a result, it is thereby possible to realize a liquid crystal display device capable of exhibiting adequate luminance in a wide range.

In the backlight device according to the present invention, it is preferable that the luminance/luminance-viewing angle improvement means is an asymmetric prism sheet having a plurality of projections on its main face.

In the backlight device according to the present invention, it is preferable that the projections of the asymmetric prism sheet have a first base angle a of 75° to 90° and a second base angle β of 45° to 60°. In the backlight device of the present invention, it is preferable that the projections of the asymmetric prism sheet have a first base angle α of 85° and a second base angle β of 50°. In this case, it is preferable that the first base angle α of the projections is positioned in the side of the light source.

In the backlight device according to the present invention, it is preferable that diffusion means is arranged between the light guide means and the luminance/luminance-viewing angle improvement means.

In the backlight device according to the present invention, it is preferable that a symmetric prism sheet, which has a plurality of projections on its main face, is arranged between the diffusion means and the luminance/luminance-viewing angle improvement means.

In the backlight device according to the present invention, it is preferable that the asymmetric prism sheet is arranged such that a ridge of the projection is perpendicular to a ridge of the projection of the symmetric prism sheet.

A liquid crystal display device

according to the present invention has the backlight device as described above.

### DESCRIPTION OF DRAWINGS

FIG. 1 shows a part of a conventional prism sheet;

FIG. 2 diagrammatically shows an arrangement of a backlight device according to an Embodiment of the present invention;

FIG. 3 shows a part of a prism sheet in the backlight device according to an Embodiment of the present invention;

FIGS. 4 and 5 show light paths in the prism sheet shown in FIG. 3;

FIG. 6 shows a graph for explaining an effect of the backlight device according to an Embodiment of the present invention;

FIGS. 7(a) and 7(b) show a mobile phone with the backlight device according to an Embodiment of the present invention;

FIG. 8 shows a PDA with the backlight device according to an Embodiment of the present invention; and

FIG. 9 shows a car navigation system with the backlight device according to an Embodiment of the present invention.

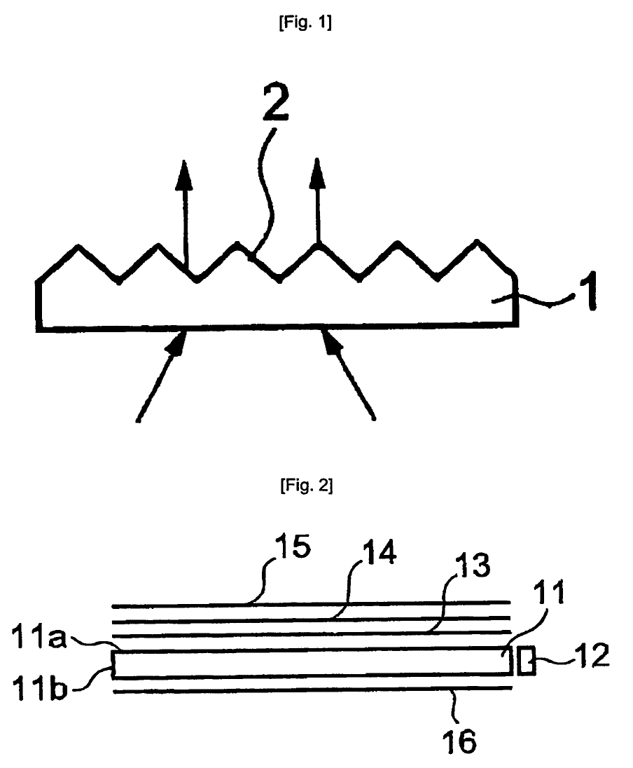

### BEST MODE

An Embodiment of the present invention will be described specifically below with reference to accompanying drawings.

FIG. 2 is a view diagrammatically showing an arrangement of a backlight device according to an Embodiment of the present invention. The backlight device of the present invention has a light guide plate 11 having main surfaces 11a and edge surfaces 11b. An edge light (side light) 12 is arranged on one edge surface side of the light guide plate 11. An LED is generally used as the edge light.

A diffusion sheet 13 for diffusing light emitted from the light guide plate 11 is arranged on the main surface 11a on the liquid crystal cell side of the light guide plate 11. The diffusion sheet 13 enables presence of the backlight not to be recognized when viewed from the panel display screen. In addition, the diffusion sheet 13 does not need to be always arranged.

A symmetric prism sheet 14 is arranged on the diffusion sheet 13. Examples used as the symmetric prism sheet 14 is BEF (Trade Name, Sumitomo 3M). The symmetric prism sheet 14 has a plurality of projections in the shape of a prism on its surface, and is arranged so that ridges of the projections are along the traveling direction of light from the light source. By this means, the symmetric prism sheet controls light in the left and right of traveling direction of the light from the light source. Accordingly, by providing the symmetric prism sheet 14, it is possible to enhance the light-gathering characteristic in the left and right of traveling direction of the light from the light source to improve the luminance. Therefore, using the sheet 14 together with an asymmetric prism sheet (described later) enables further improvements in the luminance in the vertical direction and in the luminance in wide-viewing angle directions.

On the symmetric prism sheet 14 is arranged an asymmetric prism sheet 15 that is the luminance/luminance-viewing angle improvement means. Specifically, the asymmetric prism sheet 15 has a structure as shown in FIG. 3. FIG. 3 shows a part of the prism sheet of the backlight device according to an Embodiment of the present invention.

The asymmetric prism sheet 15 has a plurality of projections 17 having a prism shape on its surface. The projection 17 comprises a first inclined surface (easy-slope inclined surface) 17a having a relatively gentle slope, and a second inclined surface (steep-slop inclined surface) 17b having a relatively steep slope. A base angle 17d on the side of the second surface 17b is α° and a base angle 17c on the side of the first surface 17a is β°. Ridges of the projection 17 are arranged to be along the direction (depth direction of the sheet as viewed in the figure) substantially perpendicular to the traveling direction of the light from the light source. In other words, the asymmetric prism sheet 15 is arranged such that the ridge of the projection 17 is substantially perpendicular to a ridge of the projection of the symmetric prism sheet. Thus, the asymmetric prism sheet 15 controls light in the traveling direction of the light from the light source.

When the light enters the asymmetric prism sheet 15, which has the above-mentioned structure, from the bottom surface 15a (light guide plate 11), the light is mainly emitted in a substantially vertical direction (a direction inclined by a relatively small angle to the vertical direction) in the first inclined surface 17a (see arrows X), and is mainly emitted in an inclined direction (a direction inclined by a relatively large angle to the vertical direction) in the second inclined surface 17b (see arrows Y).

The base angles α and β are desired to be set so as to emit the light mainly in the substantially vertical direction, while emitting the light mainly in the inclined direction, as described above. The inclined direction is determined depending on the luminance-viewing angle of the backlight device.

With respect to the base angles α and β, the angle α is desired to range from 75° to 90°, and the angle β preferably ranges from 45° to 60°. Further, with respect to a combination of the base angles α and β, for example, it is preferable that the angle α is 85° and that the base angle β is 50°.

Preferable as a material of the asymmetric prism sheet 15 is a material with a refractive index of 1.4 to 1.6. Example as the material of the asymmetric prism sheet 15 includes resin materials such as acryl-based resin, norbornene-based resin and polycarbonate.

A reflective sheet 16 is arranged on the opposite direction (the side where the diffusion sheet 13 is not arranged) to the liquid crystal cell side of the light guide plate 11.

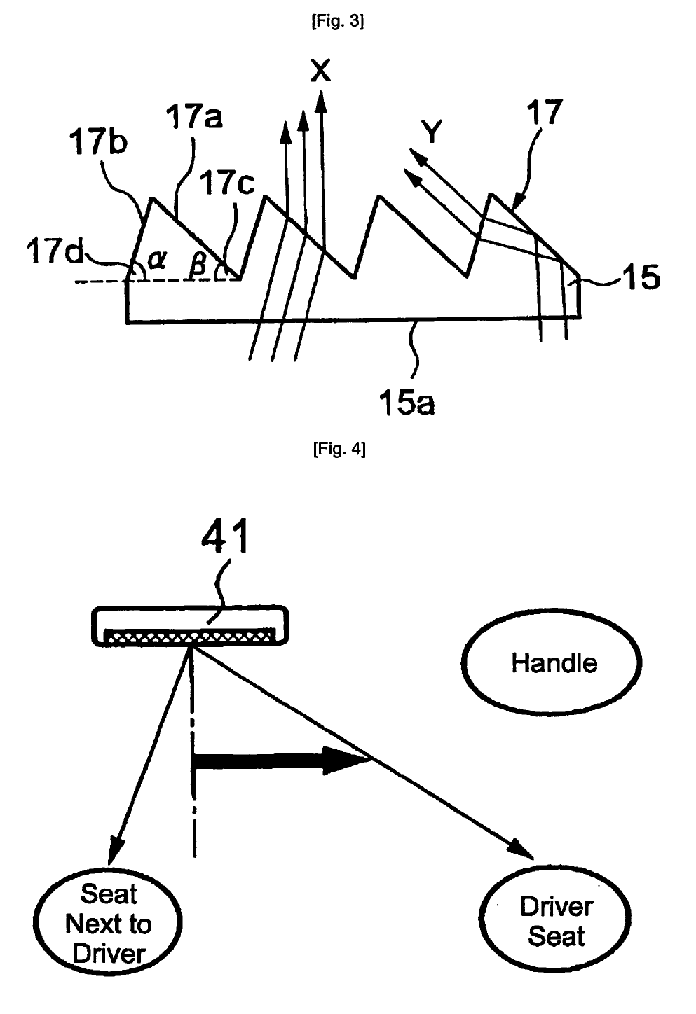

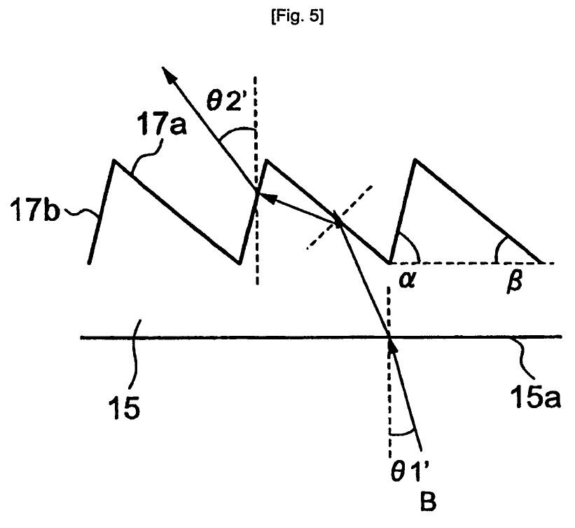

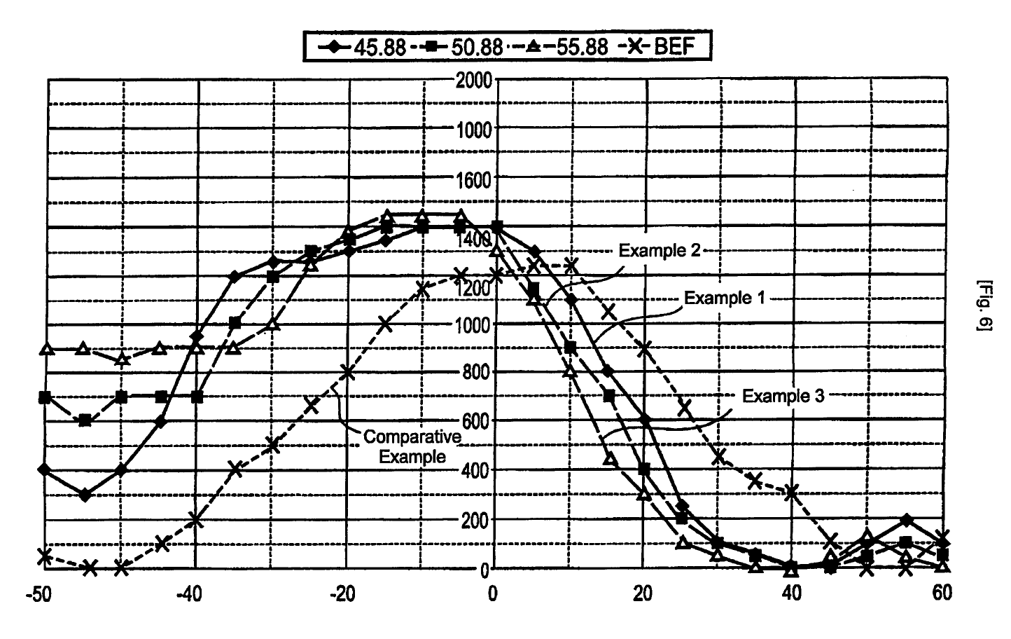

The function of the asymmetric prism sheet in the backlight device according to the present invention will be described specifically below with reference to FIGS. 4 and 5. FIGS. 4 and 5 are views for explaining light paths in the prism sheet shown in FIG. 3. In addition, in FIGS. 4 and 5, an LED as a light source is arranged on the observer's left, a nd the light travels in the direction from left to right as viewed from the observer.

As shown in FIG. 4, the light A incident on the asymmetric prism sheet 15 at an angle of θ1 to the vertical direction is refracted by the bottom surface 15a of the asymmetric prism sheet 15, further refracted by the first inclined surface 17a of the projection 17, and emitted toward the liquid crystal cell from the asymmetric prism sheet 15. At this point, since the base angle α of the projection 17 is positioned on the light source side, the emitted light has an angle of θ2 to the vertical direction. The light is thus emitted in the substantially vertical direction, and therefore, contributes to improvements in the luminance in the vertical direction.

In this case, the relationship is expressed as shown in following equation (1) between an incidence angle θ1, an outgoing angle θ2, a base angle α, and a base angle β:
θ2=β+sin⁻¹ [n1×sin {β−sin⁻¹(sin θ1)/n1}] Eq. (1)

where n1 represents a refractive index of the asymmetric prism sheet.

Further, as shown in FIG. 5, light B incident on the asymmetric prism sheet 15 at an angle of θ1′ to the vertical direction is refracted by the bottom surface 15a of the asymmetric prism sheet 15, further refracted by the first inclined surface 17a and then the second inclined surface 17b of the projection 17, and emitted toward the liquid crystal cell from the asymmetric prism sheet 15. At this point, since the base angle α of the projection 17 is positioned on the light source side, the emitted light has an angle of θ2′ to the vertical direction. The light is thus emitted in the inclined direction, and therefore, contributes to improvements in the wide luminance-viewing angle.

In this case, the relationship is expressed as shown in following equation (2) between an incidence angle θ1′, an outgoing angle θ2′, a base angle α, and a base angle β:
θ2′=−α+sin⁻¹ [n1×sin {α+2β−180−sin⁻¹(sin θ1′)/n1}] Eq. (2)

where n1 represents a refractive index of the asymmetric prism sheet.

Accordingly, in the case of determining base angles α and β of the projection 17 of the asymmetric prism sheet 15, with consideration given to outgoing angles θ2 and θ2′, it is desirable to determine the angles based on expressions (1) and (2) as described above. In particular, since the luminance-viewing angle is arbitrary, it is desirable to determine base angles α and β depending on the angle θ2′.

The backlight device with the structure as described above is arranged on the rear side (opposite side to the display side) of the liquid crystal cell in a liquid crystal display device. In the liquid crystal display device, the light from the edge light 12 of the backlight device propagates inside the light guide plate 1 1, and a part of the light is emitted directly to the liquid crystal cell side, while the other part of the light is reflected by the reflective sheet 16 arranged on the opposite side to the liquid crystal cell side of the light guide plate 11. The light reflected by the reflective sheet 16 is passed through the light guide plate 11 and emitted to the liquid crystal cell side. The light emitted from the light guide plate 11 is diffused by the diffusion sheet 13. The light passed through the diffusion sheet 13 is controlled by the symmetric prism sheet 14 so that the light-gathering characteristic is enhanced in left-right directions (directions to the left and right to the traveling direction of light from the light source).

Then, the light passed through the symmetric prism sheet 14 is refracted by the projection 17 of the asymmetric prism sheet 15, and emitted in the substantially vertical direction, while being emitted in the inclined direction, as described above. In other words, the asymmetric prism sheet 15 emits the light in the normal direction to the main surface of the light guide plate and in the direction at a predetermined angle to the normal direction. Thus emitted light is incident on the liquid crystal cell.

In this way, according to the asymmetric prism sheet of the backlight device of the present invention, the light is emitted in the substantially vertical direction, while being emitted in the inclined direction, and it is thereby possible to improve the luminance in the vertical direction of the liquid crystal display device, while realizing a wide luminance-viewing angle.

Examples will be described below which were carried out to clarify effects of the present invention.

Three backlights were prepared such that on one main surface of the light guide plate are laminated the diffusion sheet, the symmetric prism sheet and the asymmetric prism sheet in this order, the reflective sheet is provided on the other main surface of the light guide plate, and that an LED is arranged as an edge light on one edge surface side of the light guide plate. The three backlights are respectively set for combinations of base angles α and β of a projection of the asymmetric prism sheet, (88°, 45°) (Example 1), (88°, 50°) (Example 2) and (88°, 55°) (Example 3). Further, as a comparative example, a backlight was prepared such that on one main surface of the light guide plate are laminated the diffusion sheet, and two symmetric prism sheets (BEF) in this order, the reflective sheet is provided on the other main surface of the light guide plate, and that an LED is arranged as an edge light on one edge surface side.

Liquid crystal display devices were obtained by combining four backlights and a liquid crystal panel. A simulation was carried out on the luminance-viewing angle of each of the liquid crystal display devices. Luminance of the light on the backlight was measured in the simulation. The luminance of the light was measured in a generally-used luminance meter, and the luminance at each angle was obtained. It is herein assumed that the normal direction to the light-emitting surface of the backlight is viewing angle 0°. FIG. 6 shows the simulation results.

As can be seen from FIG. 6, each of liquid crystal display devices (Examples 1 to 3) using the backlight according to the present invention exhibits high luminance in the vertical direction, while having a wide luminance-viewing angle. In particular, with respect to the luminance in the vertical direction, each of the devices has a higher value than that of the liquid crystal display device of the comparative example. On the other hand, the liquid crystal display device of the comparative example exhibits high luminance in the vertical direction, but the luminance-viewing angle thereof is narrow.

Application examples of the backlight device according to the present invention will be described below.

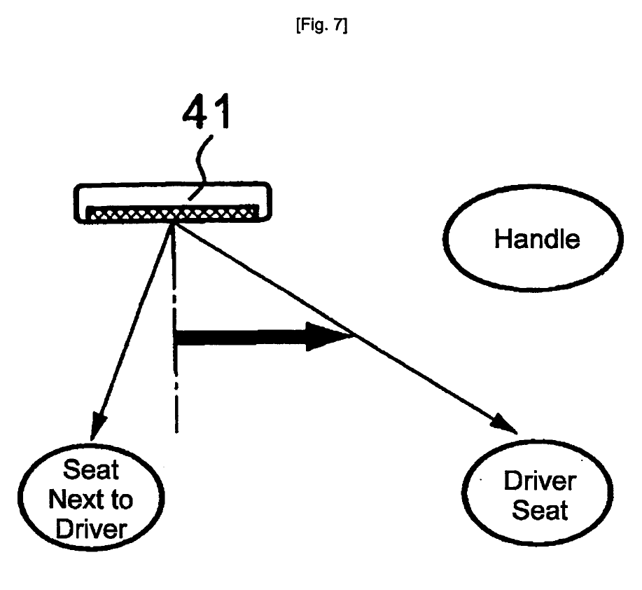

FIG. 7(a) is a view showing a mobile phone with a conventional backlight device, and FIG. 7(b) is a view showing a mobile phone with the backlight device according to the present invention. A mobile phone 22 with the backlight device of the present invention has a luminance-viewing angle wider than that of a mobile phone 21 with the conventional backlight device, and therefore, enables an image display with a wide range and excellent viewing.

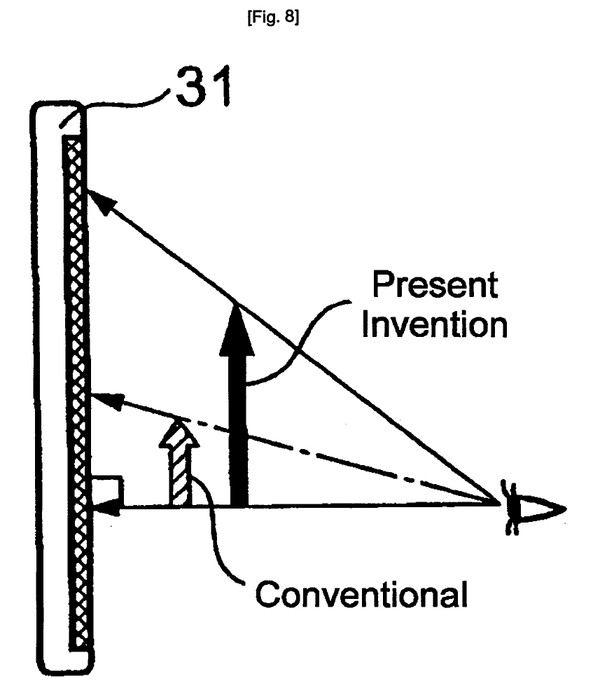

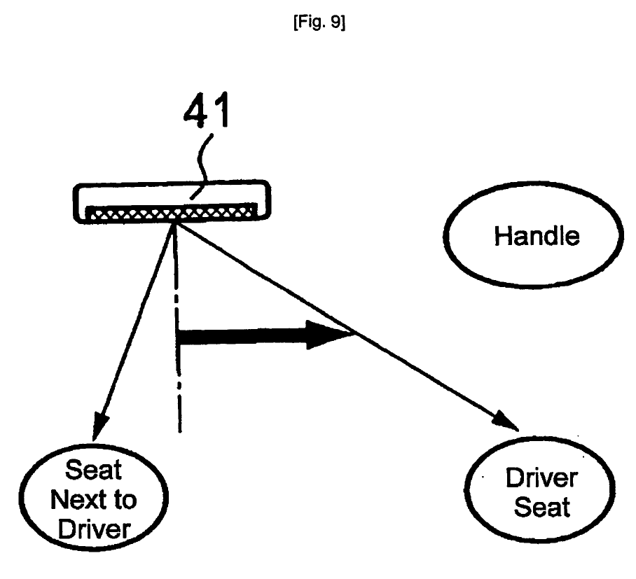

FIG. 8 is a view showing a PDA with the backlight device according to the present invention. Also in this case, a PDA 31 with the backlight device of the present invention has a luminance-viewing angle wider than that of a PDA with the conventional backlight device, and therefore, enables image display with a wide range and excellent viewing.

FIG. 9 is a view showing a car navigation system with the backlight device according to the present invention. Also in this case, a monitor 41 for the car navigation system with the backlight device of the present invention has a luminance-viewing angle wider than that of a monitor with the conventional backlight device, and therefore, enables an image display with a wide range and excellent viewing. For example, as shown in FIG. 9, an image displayed on the monitor 41 installed on the passenger side can be viewed in an excellent viewing state to a person at the driver seat as well as a person at the seat next to the driver.

The present invention is not limited to the aforementioned Embodiment, and is capable of being carried into practice in various modifications thereof. For example, the aforementioned Embodiment describes the case of applying the backlight device according to the present invention to a liquid crystal display device for each of a mobile phone, PDA and car navigation system. The present invention is further applicable to liquid crystal display devices for all applications requiring the luminance in the vertical direction and wide luminance-viewing angle.

Further, the Embodiment describes the case of using the asymmetric prism sheet as the luminance/luminance viewing angle improvement means, but the present invention is not limited to such a case. As long as a member emits an incident light in the substantially vertical direction, while emitting the light in the inclined direction, any member is usable other than the asymmetric prism sheet.

Furthermore, the diffusion sheet and/or reflective sheet in the Embodiment is not limited to the shape of a sheet, and may be in the shape of a plate or a film, as long as the diffusion effect and/or reflection effect is exhibited, respectively. The symmetric prism sheet is not limited to the shape of a sheet either, as long as its function is exhibited.

As described above, the backlight device of the present invention comprises light guide means that has a pair of main faces facing each other and a pair of edge faces facing each other and that guides the light from a light source arranged at one of the edge faces, luminance/luminance-viewing angle improvement means that is arranged in the side of one main face of the light guide plate and that emits the light in a substantially normal direction to the main face and in the direction having a predetermined angle to the normal direction, and reflective means arranged on the other main face of the light guide means. It is thereby possible to realize a liquid crystal display device exhibiting the improved luminance in the vertical direction and the wide luminance-viewing angle.

### INDUSTRIAL APPLICABILITY

The present invention is applicable to a backlight device used as a light source of a liquid crystal display device of a mobile phone, PDA (Personal Digital Assistant, car navigation system, or the like.

1. A backlight device comprising:
light guide means, having a pair of main faces facing each other and edge faces, for guiding the light from a light source arranged at one edge face;
luminance/luminance-viewing angle improvement means, arranged on the side of one main face, emitting the light in a substantially normal direction to said main face and a direction of having a predetermined angle to the normal direction; and
reflective means arranged on another main face of said light guide means.

2. A backlight device as claimed in claim 1, wherein said luminance/luminance-viewing angle improvement means is asymmetric prism sheet having a plurality of projections.

3. A backlight device as claimed in claim 2, wherein said projections of said asymmetric prism sheet have a first base angle α of 75° to 90° and a second base angle β of 45° to 60°.

4. A backlight device as claimed in claim 2 or 3, wherein said projections of said asymmetric prism sheet have a first base angle α of 85° and a second base angle β of 50°.

5. A backlight device as claimed in claim 3 or 4, wherein said first base angle α of projections is positioned at the side of said light source.

6. A backlight device according to any one of claims 1 to 5, wherein diffusion means is arranged between said light guide means and said luminance/luminance-viewing angle improvement means.

7. A backlight device as claimed in claim 6, wherein a symmetric prism sheet, which has a plurality of projections, is arranged between said diffusion means and said luminance/luminance-viewing angle improvement means.

8. A backlight device as claimed in claim 7, wherein said asymmetric prism sheet is arranged such that a ridge of said asymmetric prism sheet is substantially perpendicular to a ridge of said symmetric prism sheet.

9. A liquid crystal display device comprising a backlight device as claimed in any one of claims 1 to 8.
